(19) United States
(12) Patent Application Publication
(10) Pub. No.: US 2007/0064726 A1
(43) Pub. Date: Mar. 22, 2007

(54) Endpoint transparent independent messaging scheme system and method

(75) Inventor: Andy E. Rostron, Melbourne, FL (US)

Correspondence Address: DUANE MORRIS LLP, 1667 K Street, N.W., Washington, DC, 20006, US

(73) Assignee: HARRIS CORPORATION

(21) Appl. No.: 11/230,453

(22) Filed: Sep. 21, 2005

(51) Int. Cl. H04J 15/00

(52) U.S. Cl. 370/464

(57) ABSTRACT

A software based system and method for facilitating connection-oriented data communication over a plurality of communication channels between endpoint software modules. Communication connection modules facilitate communication in at least one protocol between endpoint software modules via the plurality of communication channels, whereby the addressing data requirements on the software modules are reduced.

### CROSS REFERENCE TO RELATED APPLICATIONS

The present application is related to co-pending and commonly assigned PCT International Application No. PCT/US02/03323 entitled “Dynamic Bandwidth Allocation”, PCT/US02/03322 entitled “Demodulator Bursty Controller Profile”, PCT/US02/03193 entitled “Demodulator State Controller”, PCT/US02/03189 entitled “Frame to Frame Timing Synchronization”, the disclosures of which are hereby incorporated herein by reference. The aforementioned applications are related to commonly assigned U.S. Pat. No. 6,016,313 entitled “System and Method for Broadband Millimeter Wave Data Communication” issued Jan. 18, 2000 and currently undergoing two re-examinations under Application Ser. No. 90/005,726 and application Ser. No. 90/005,974, U.S. Pat. No. 6,404,755 entitled “Multi-Level Information Mapping System and Method” issued Jun. 11, 2002, U.S. patent application Ser. No. 09/604,437, entitled “Maximizing Efficiency in a Multi-Carrier Time Division Duplex System Employing Dynamic Asymmetry”, which are a continuation-in-part of the 6,016,313 patent which are hereby incorporated herein by reference.

The present application is related to co-pending and commonly assigned U.S. patent application Ser. No. 10/183,383, entitled “Look-Up Table for QRT”, U.S. patent application Ser. No. 10/183,488, entitled “Hybrid Agent-Oriented Object Model to Provide Software Fault Tolerance Between Distributed Processor Nodes”, now U.S. Pat. No. 6,868,067, U.S. patent application Ser. No. 10/183,486, entitled “Airlink TDD Frarne Format”, U.S. patent application Ser. No. 10/183,492, entitled “Data-Driven Interface Control Circuit and Network Performance Monitoring System and Method”, U.S. patent application Ser. No. 10/183,490, entitled “Virtual Sector Provisioning and Network Configuration System and Method”, U.S. patent application Ser. No. 10/183,489, entitled “System and Method for Supporting Automatic Protection Switching Between Multiple Node Pairs Using Common Agent Architecture”, U.S. patent application Ser. No. 10/183,384, entitled “System and Method for Transmitting Highly Correlated Preambles in QAM Constellations”, the disclosures of which is hereby incorporated herein by reference.

### BACKGROUND OF THE INVENTION

In Point to Point communication system (“PTP” ) messages or data from a source node to a destination node are transmitted over a dedicated channel or line between the source and destination nodes (i.e. software processes or processor nodes). PTP systems allow communication between only two nodes or entities.

Point to multipoint (singlecast, multicast, or broadcast) connected entities, within a communication system can only receive and send messages from the source to a destination node through a hub or host. The messages or data in these systems contain information indicating the address or identity of the target node. In PMP system using a broadcast method all the connected entities or nodes receive the message only those target destinations intended to receive the information process the information, in such system an additional link is required to send messages to the hub. In PMP communication systems a message sent to a target node from a source node travels to the hub and then from the hub to the target node. Therefore, as communication between the nodes increases the hub or host can become an unnecessary choke point limiting the rate of data exchange. Furthermore when multiple target nodes are intended, the hub may be required to copy the message, one fore each additional target node, thus placing further strain on the resources of the communication system.

A multipoint to multipoint (MTM) system allows each connected, or subscribing entity to communicate messages with any of the other connected or subscribing entities. Consequently, each entity in the multipoint-to-multipoint system must maintain an address table containing the address of each entity in the system in order to facilitate communications in the MTM system. This requirement presents problems for large MTM systems. For example, maintaining large address tables for each system entity requires a large amount of memory space and therefore increases the cost of the system. Additionally, the probability of having an address error in the system increases as a function of the number of addresses that need to be stored in memory. Furthermore, the addition and/or deletion of an entity from the system requires updating each address table on the system which significantly increases the maintenance overhead of the system.

Sending messages to desired entities in prior art methods PTP, PMP and MTM requires the sending entity to know the address of the intended recipient entity. Processes that share information back and forth with other processes need the address or specific connection to communicate or directed the message.

Prior art processors are typically hard coded, that is their connections to other processors and respective databases are predetermined and specifically referenced in the code. Changes in system configurations and access to additional databases requires re-coding each processor not to reflect the changes and additions.

Therefore, there is a need for a communication system and method in an MTM system that overcomes the above-mentioned problems.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is an embodiment of a software based system for facilitating connection-oriented data communication according to the disclosure.

FIG. 2 is an embodiment of a common channel architecture according to the disclosure.

FIG. 3 is an embodiment of common channel architecture with a common channel and a private channel according to the disclosure.

FIG. 4 is another embodiment of a software based system for facilitating connection-oriented data communication according to the disclosure.

### DETAILED DESCRIPTION

A common channel server is a software messaging entity that facilitates communication between multiple processor nodes. The common channel server is a connectionless implementation of a UNIX standard Remote Procedure Call (RPC). RPC is a connection-oriented implementation of classic point to multi-point models. Specifically, with a common channel server the endpoints or processor nodes do not require the target's address to send a message, thereby providing an improvement that reduces software coupling, improve portability and encourages reuse.

The Common Channel Server mechanism, which is hidden from the endpoints, can utilize either a connectionless or connection-oriented approach, depending in large part upon the communication medium. The common channel server abstracts the communication medium into a generic form in much the same manner as a hardware abstraction layer.

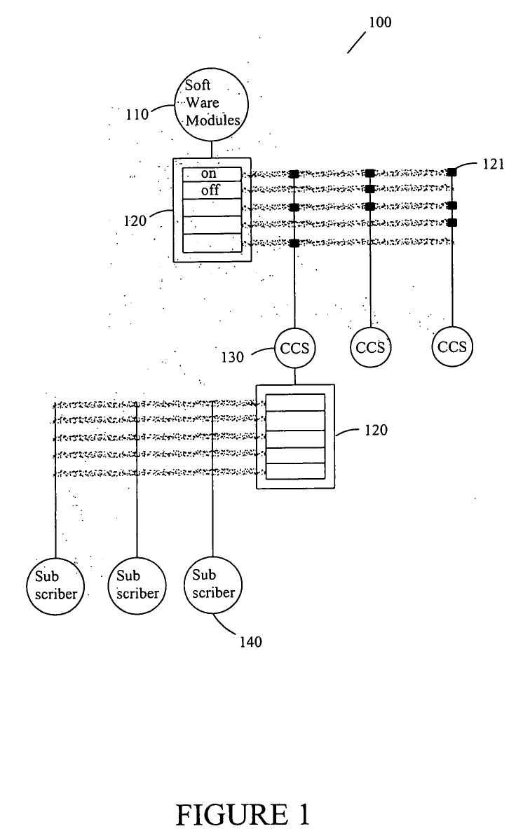

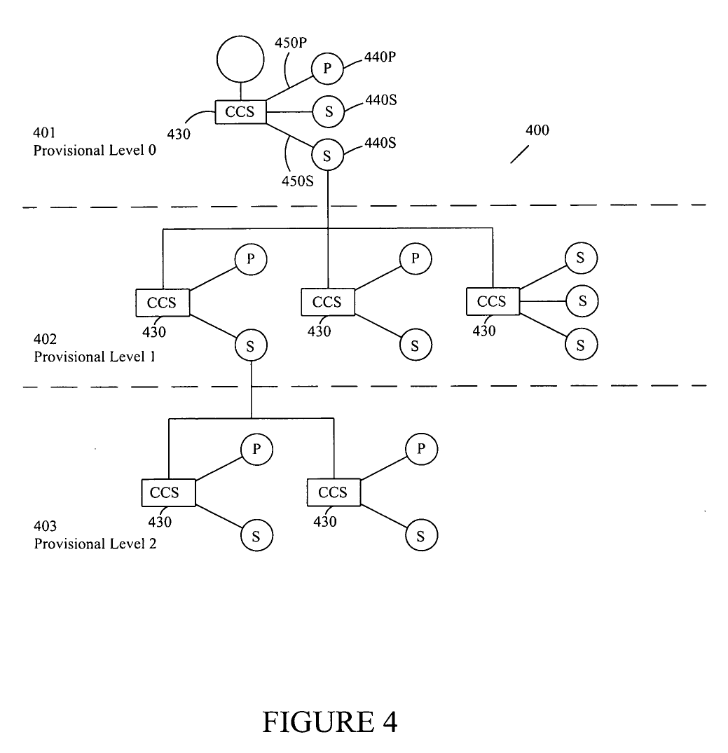

An embodiment of a software-based system for facilitating connection-oriented data communications according to the invention is shown in FIG. 1. The system 100 includes a software module 110 that functions as a provider. The provider 110 provides data over a plurality of predetermined communications channels 120. The communication channels 120 can be implemented through a variety of protocols TCP, IP, ATM etc. A plurality of common channels servers (CCS) 130 are hung of at least one of the plural channels 120. The CCS 130 exchange data over the plural channels 120. In the embodiment of FIG. 4, all of the CCS's 130 are attached or subscribed to channel 121. Thus any data or command on channel 121 is accessible by the CCS'a or the Provider 110. In this manner the CCS can communicate with each of the other CCS's without the need to address the target entity. The CCS can also communicate with a second set of software modules the function as subscribers 140. The communication between the subscribers 140 and the CCS is facilitated by a second layer of communication channels 150 as shown in FIG. 1. In the embodiment shown in FIG. 1, the CCS's 130 control there attachment to the channels and thus are not effected by others hanging from the same channel, therefore replacement and reconfiguration of the system is easily facilitated. The attachment of the subscriber modules 140 to the second set of communication channels 150 is similarly implemented.

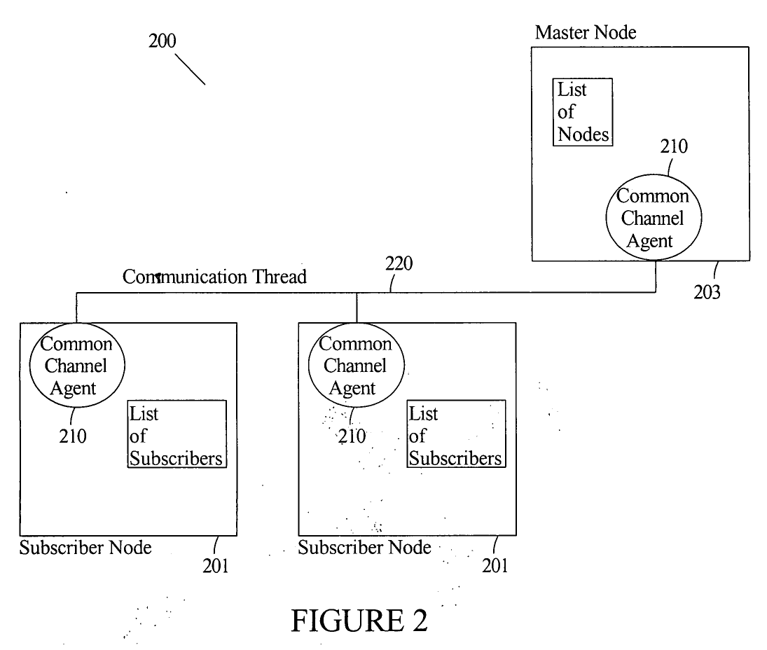

Another embodiment of a communication system utilizing a Common channel server mechanism is shown in FIG. 2. The communication system 200 has a plurality of processor nodes 201, 202 and 203 but is not limited to those shown in FIG. 2. The common channel server resides on each of the node and may be implemented by a common channel agent 210. One node per common channel is designated as a master node 203 much like in classical point-to-multi-point models.

Each of the Common channel nodes has public and private channels. The public channel (the common channel) allows communication between the Common channel nodes. The private channel allows communication on same board of a particular Common Channel server. The nodes are operably connected by a communication thread 220, which carries the messages via the channel. A channel represents a data service that processes or agents can subscribe and/or contribute to.

In the implementation of the CCS system there is no code coupling between the processes, such coupling is supplanted by the access provided by the Common Channel Server. Furthermore, the processes or agents are unaware and unaffected by the number of nodes or other processes that hang off a channel. The process addresses the common channel and all remote processor on that common channel are able to receive the data message.

The common channel agents relay the data messages from the common channel to the respective processor node and vice versa. The common channel agent also formats the message for use by the respective processor node.

Each common channel maintains a list of known subscriber nodes, as well as a list of attached subscriber nodes. The common channel uses an auto-discovery process that initiates when a subscriber node attaches or is removed for the common channel.

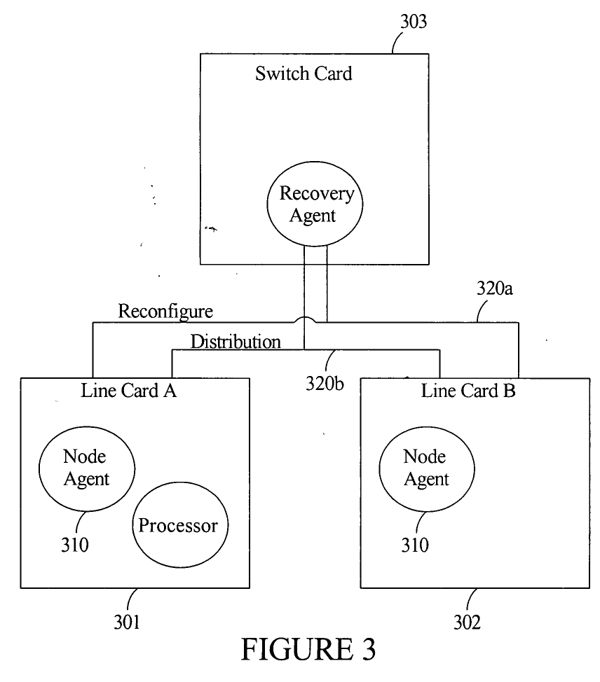

FIG. 3 is an implementation of the Common Channel Server mechanism with two Common Channels. The master node 303 is a switch card for a communication system. Processor node 301 is line card A and processor node 302 is line card B. Both processor nodes are operably connected to the master processor node 303 via a “reconfigure channel” and a “distribution channel”. The reconfigure channel is a Common channel, which communicates through communication thread 320. The distribution channel is a private channel that can be directed to specific node agents. The private channel communicates over communication thread 321. Processor nodes 301 and 302 both have a node agent 210.

For illustration a “notifiy_update” message is sent from the node agent 310 of line card A regarding a slot ID update. The node agent 310 passes the message through the reconfigure channel. The switch card sends records, needed to reconfigure switch card A over the distribution channel (singlecasted to specific CCS on the line Card A). The switch cards then sends a reconfigure command regarding the slot ID update over the reconfigure channel. Every processor on the reconfigure channel sees the reconfiguration message and reconfigures itself as necessary.

The common channels also facilitate auto-discovery as alluded to above. Several techniques utilizing the common channel can be used. The master processor can send a generic update message periodically requesting status, in which the processors return a status. The master would thus recognize new processor nodes. Alternatively, over the common channel, the newly attached processor would send out a notify update. The master processor would follow both methods by a response command over a common reconfigure channel reconfiguring the system including the newly attached processor.

FIG. 4 is an embodiment of software-based system for facilitating connection-oriented data communication between a plurality of software modules 440s and 440p across a communication medium, typically the existing communication means in a hierarchical computer environment having more than one layer using at least one communication protocol, such as TCP, IP, ATM, etc. The system 400 has first or private communication channel designated as 450p and second or public communication channel designated as 450s within the communication medium; and

a plurality of software interface modules, such as common channel servers 430 (CCS) each capable of sending data to and receiving data from a unique set of select ones of said software modules 440 via said first communication channel 450p and operatively connected to said second communication channel 450s. Each of said interface modules 430 communicate with other interface modules over said second communication channel 450s by sending and receiving data without requiring the address of the sending or the receiving. The communication may be facilitated with an interface or software module that is connection oriented and without requiring link establishment and link tear down procedures to thereby provide connection-oriented data communication.

The embodiment shown in FIG. 4, has three different provisioned levels, provisioned level 0 401, level 1 402 and level 2 403. The provisioned levels form a hierarchical computer environment.

While preferred embodiments of the present invention have been described, it is to be understood that the embodiments described are illustrative only and the scope of the invention is to be defined solely by the appended claims when accorded a full range of equivalence, many variations and modifications naturally occurring to those of skill in the art from a perusal hereof.

I claim:

1. A software-based system for facilitating connection-oriented data communication over a plurality of predetermined communication channels, comprising:
a first software module capable of providing data to at least one of said plural communication channels;
a plurality of second software modules each capable of providing data to and receiving data from at least one of said plural channels, wherein one of said second modules is capable of transmitting said data to a third software module;
said third software module capable of receiving said data from said second module over a second plurality of predetermined communication channels.

2. In a hierarchical computer environment comprising a plurality of software modules ones of which are capable of sending data across a communication medium to others of said modules using at least one communication protocol, the improvement comprising a software-based abstraction layer including a communication connection server for facilitating connection-oriented data communication across the communication medium between said software modules without requiring the sending module to obtain the address of the receiving module and without requiring link establishment procedures.

3. A software-based system for facilitating connection-oriented data communication between a plurality of software modules across a communication medium in a hierarchical computer environment using at least one communication protocol comprising:
a first communication channel in said communication medium;
a second communication channel in said communication medium; and
a plurality of software interface modules each capable of sending data to and receiving data from a unique set of select ones of said software modules via said first communication channel and operatively connected to said second communication channel,
whereby each of said interface modules communicate with other interface modules over said second communication channel by sending and receiving data without requiring the address of the sending or the receiving module and without requiring link establishment and link tear down procedures to thereby provide connection-oriented data communication.

4. In a hierarchical computer environment comprising a plurality of software modules at least one of which is capable of sending data across a communication medium for reception by at least one other of said modules, said sending module using a communication protocol comprising the steps of obtaining the address for the recipient module, establishing a communication link to the recipient module, sending said data across the established link, and tearing down the established link, the improvement comprising a software-based communication abstraction layer operatively connected to said sending and receiving modules, said abstraction layer including a communication connection server for facilitating connection-oriented data communication across the communication medium on a predetermined channel to which said sending and receiving modules are attached to thereby allow said sending module to send data to said recipient module without requiring the address of the recipient module and without requiring the steps of link establishment and link tear down.

5. In a method of communication between processor nodes, in a communication system comprising a plurality of processor nodes, the improvement of using a common channel agent residing on each processor node, whereas the common channel agent communicates with each of the plural processor nodes through their respective common channel agents via a predetermined common channel, such that a transmitting processor node does not require a target's address to send a message.

6. The method of claim 5, where the processor is a data service to which other processor nodes can subscribe.

7. The method of claim 5, where each common channel agent maintains a list of subscriber nodes.

8. The method of claim 5, where one of the processor nodes is configured as the master.

9. The method of claim 5, where the channel is a communication thread connected to the plurality of processor nodes.

10. The method of claim 5, wherein the common channel agents relay messages from their respective processor node to the common channel.

11. The method of claim 10, wherein the common channel agents format the message for the common channel.

12. The method of claim 5, wherein the communication system comprises multiple channels, wherein a first subset of processor is said plurality of processors is connected to a first channel and a second subset of processors in said plurality of processors connected to a second channel.

13. The method of claim 12, wherein said master processor node is connected to each of the multiple channels.

14. The method of claim 13, wherein said master processor node sends messages type A over a first channel and message type B over a second channel.

15. A communication system with a plurality of processor nodes and a intra-communication system for communication between the plurality of processor nodes, the improvement comprising a common channel connecting each one of the plurality of processor nodes to each of the other plurality of processor nodes.

16. The communication system of claim 15, wherein the system is Time division duplex.

17. The communication system of claim 16, where the system is adaptive.

18. The communication system of 17, where the system is for short range radio communication of bursty data from one computer network to another.

19. The communication system of 18, wherein each of the processor nodes are connected to the common channel through a common channel agent.

20. The communication system of 18, wherein the common channel is a communication thread.

21. The communication system of 18, wherein the system contains multiple common channels.

22. The communication system of 21, wherein the multiple common channels includes a distribution channel and a reconfiguration channel.

23. The communication system of claim 15, wherein each processor node is connected to said master via said common communication channel and a private channel.

24. The communication system of claim 15, wherein the system includes auto discovery system.

25. In a method for transmitting a message from a 1^{st} processor to a 2^{nd} processor in a communication system comprising a plurality of processors operatively connected to a common communication channel, the improvement of transmitting a message from said 1^{st} processor to said 2^{nd} processor where said 1^{st} processor does not know the address of said 2^{nd} processor.

26. The method of claim 25, where said 1^{st} processor transmits a message so said 2^{nd} processor by addressing said common communication channel.

27. In a method of configuring a communication system comprising plural processors operationally connective to a common channel, wherein each processor includes a hardcoded table containing the address of all of the other processors in the communication systems so as to be able to transmit a massage to any one of said other processors, the improvement of adding a common channel agent to each processor wherein each common channel agent incorporates an autodiscovery feature and a soft coded table to replace said hard wired table so as to enable a one of said plural processors to communicate with another of said plural processors without incorporating the address of the said other plural processor to thereby enable said communication system to reconfigure without accessing said hard codes tables.
